(19) United States
(12) Patent Application Publication
(10) Pub. No.: US 2022/0297238 A1
(43) Pub. Date: Sep. 22, 2022

(54) METHOD FOR PRODUCING AN ARRESTER FOIL FOR BATTERIES

(71) Applicant: VOLKSWAGEN AKTIENGESELLSCHAFT, Wolfsburg (DE)

(72) Inventors: Alexander Breuer, Celle (DE); Lars Fietkau, Wendeburg (DE)

(73) Assignee: VOLKSWAGEN AKTIENGESELLSCHAFT, Wolfsburg (DE)

(21) Appl. No.: 17/697,460

(22) Filed: Mar. 17, 2022

(30) Foreign Application Priority Data
Mar. 18, 2021 (DE) 10 2021 202 644.3

(51) Int. Cl. B23K 26/38; B23K 26/08; H01M 4/04

(52) U.S. Cl. CPC B23K 26/38; B23K 26/083; H01M 4/04; B23K 2101/36

(57) ABSTRACT

In a method for producing an arrester foil for a battery, a roll with a metallic raw foil is prepared. While the roll is being continuously unrolled at an advancing speed in the advancing direction, a laser cutting group cuts out connections in an edge area of the unwound raw foil extending along the advancing direction. The invention also relates to a production device.

### CROSS REFERENCE TO RELATED APPLICATION

This application claims priority from German Patent Application No. 10 2021 202 644.3, filed Mar. 18, 2021, which is hereby incorporated by reference in its entirety.

### FIELD OF THE INVENTION

The invention relates to a method for producing an arrester foil for batteries and it also relates to a production device.

### BACKGROUND OF THE INVENTION

To an increasing extent, motor vehicles are powered, at least partially, by means of an electric motor, meaning that they are configured as electric vehicles or as hybrid vehicles. The power supply of the electric motor is normally obtained from a high-voltage battery that comprises several individual battery modules. For the most part, the battery modules have an identical design, and they are electrically connected to each other in series and/or in parallel, so that the electric voltage present at the high-voltage battery amounts to a multiple of the electric voltage supplied by each of the battery modules. Each battery module, in turn, comprises several batteries that are normally arranged in a shared housing and that are electrically connected to each other in series and/or in parallel.

Each one of the batteries, in turn, normally comprises several battery cells, which are each also referred to as a galvanic element. Each one of these cells has two electrodes, namely an anode and a cathode as well as a separator arranged between them, and also an electrolyte with freely moving charge carriers. A liquid, for example, is employed as such an electrolyte. In an alternative, the battery is configured as a solid-state battery and the electrolyte is present as a solid.

The anode and the cathode that form the electrodes of the battery cell normally comprise a current arrester, also referred to simply as an arrester or as a carrier. An active material, which is a constituent of a coating applied onto the carrier, is affixed thereto. In this context, the electrolyte can already be present in the coating, or else it can be introduced subsequently. At least, however, the active material is suitable for receiving the working ions, for instance, lithium ions. Depending on the application as either an anode or as a cathode, a different material is employed for the carrier and a different type of material is used for the coating.

The arresters are normally made of a metal foil so that the electrodes are relatively thin. To start with, the metal foil is usually present as a raw foil in roll form. The coating is applied onto it and then hardened. Subsequently, the product in roll form is cut to length, thereby producing each individual electrode. For purposes of simplifying the electric contacting of the electrode, the coating is not applied over the entire surface area of the raw foil, but rather, an edge area is left free of the coating, so that direct electric contacting with the arrester is made possible there. Only a relatively small section of the edge area is required for this, and the remaining part of the edge area is not needed. The edge area in this part is usually left free so that this space can be used for other purposes, whereby this is usually done before the coating is applied.

Normally, in order to create these cutouts, the raw foil is first unwound and fed to a stamping machine. This machine then stamps the edge area so that the sections are retained as connections and the remaining parts are cut off. Subsequently, the raw foil that had been processed in this manner is wound up again and can be placed into intermediate storage. Immediate further processing, especially the application of a coating, is also an option.

The stamping process requires that the unwound section of the raw foil to be stamped not be moved. Therefore, the section of the roll is first unwound and fed into the stamping machine. Subsequently, the roll is brought to a standstill and the stamping machine is actuated. After that, this stamping machine [sic] is removed from the stamping machine, and for this purpose, the roll is unwound once again, thereby feeding a new section of the raw foil to the stamping machine. This is followed by a cycled processing of the raw foil. Consequently, on the one hand, a relatively high stress is exerted onto the raw foil. On the other hand, the material properties of the raw foil prescribe the maximum acceleration and deceleration. As a result, it is not possible to increase the production speed beyond a certain level.

### SUMMARY OF THE INVENTION

The invention is based on the objective of putting forward an especially suitable method for producing an arrester foil for batteries as well as an especially suitable production device for producing an arrester foil, whereby advantageously flexibility is increased and/or rejects are reduced.

This objective is achieved according to the invention by the features of the claims regarding the method, and by the features of the claims regarding the production device. Advantageous refinements and embodiments are the subject matter of the appertaining subordinate claims.

The method serves for the production of an arrester foil for batteries. In this process, for instance, it is possible to produce just one single arrester from the arrester foil. Especially preferably, however, several arresters can be produced from the arrester foil. When the produced arrester foils are in their proper state, they are each a component of an electrode of the appertaining battery. In this context, the electrodes produced from the arrester foil are, for example, anodes or cathodes. Each of the electrodes advantageously comprises a coating that is applied onto the appertaining arrester. The coating especially comprises an active material that is suitable, especially provided and configured to receive working ions such as lithium ions. The active material used is, for instance, a lithium metal oxide such as lithium-cobalt(III)-oxide (LiCoO₂), NMC, NCA, LFP, GIC, LTO. As an alternative, NMC622 or NMC811 is used as the active material.

For example, several electrodes are stacked one above the other for the appertaining battery, whereby the anodes and the cathodes alternate here, and whereby a separator is arranged between each of the individual electrodes. In other words, the battery comprises a cell stack. As an alternative to this, the arrester foil or at least part of it is wound up, and the battery comprises a so-called “jelly roll”.

When the produced batteries are in their proper state, they are preferably a component of a motor vehicle. The batteries are suitable, especially provided and configured for this purpose. When the produced batteries are in their proper state, they are, for instance, a component of an energy storage means of the motor vehicle comprising several such batteries. In this context, the battery cells are preferably divided into several battery modules which, in turn, have an identical design. In particular, the battery cells are arranged in a housing of the energy storage means or of the appertaining battery module and are electrically connected to each other in parallel and/or in series. Therefore, the electric voltage present at the energy storage means or at the battery module amounts to a multiple of the electric voltage supplied by each of the batteries. The housing of the energy storage means or of the appertaining battery module is preferably made of a metal, for example, a steel such as stainless steel, or of an aluminum alloy. A high-pressure die casting method, for example, is used for its production. In particular, the housing of the energy storage means or of the appertaining battery module has a closed configuration. Advantageously, an interface is installed in the housing of the energy storage means or of the appertaining battery module in order to create a connection for the energy storage means or for the battery module. In this process, electric contact is established between the interface and the battery, so that electric energy can be fed into and/or drawn from the batteries from outside of the energy storage means, provided that an appropriate plug has been inserted into the connection.

The motor vehicle is preferably a ground vehicle and preferably has a number of wheels of which at least one, preferably several or all of them, are powered by a drive. In a suitable manner, one, preferably several, of the wheels are configured so that they can be steered. This makes it possible to move the vehicle independently of a specific road surface such as, for instance, rails or the like. In this context, it is advantageously possible to position the motor vehicle essentially on any desired road surface which is especially made of asphalt, tar or concrete. The motor vehicle is, for example, a utility vehicle such as a truck or a bus. Especially preferably, however, the motor vehicle is a passenger car.

The locomotion of the motor vehicle is advantageously achieved by means of the drive. For instance, the drive, especially the main drive, is configured so as to be at least partially electric, and the motor vehicle is, for example, an electric vehicle. The electric motor is operated, for instance, by means of the energy storage means that is suitably configured as a high-voltage battery. The high-voltage battery advantageously provides electric direct voltage, whereby the electric voltage ranges, for example, from 200 volts to 800 volts, and essentially 400 volts by way of an example. Preferably, an electric converter is arranged between the energy storage means and the electric motor and it serves to energize the electric motor. In an alternative, the drive additionally has an internal combustion engine so that the motor vehicle is configured as a hybrid vehicle. In an alternative, the energy storage means supplies a low-voltage on-board system of the motor vehicle, and it also especially provides electric direct voltage of 12 volts, 24 volts or 48 volts.

In another alternative, the battery is a component of a forklift truck, an industrial installation or a handheld device such as, for instance, a tool, especially a cordless electric screwdriver. In another alternative, the battery is a component of an energy supply unit and is employed there, for example, as a so-called buffer battery. In another alternative, the battery is a component of a portable device, e.g. a portable mobile telephone, or another wearable. It is likewise possible to use such a battery in the realms of camping and model building or for other outdoor activities.

The method provides that, first of all, a roll with a metallic raw foil is prepared. In other words, the raw foil is rolled up together to form a roll. The raw foil is made of a metal, whereby the metal is coordinated with the type of electrode that is going to be produced by means of the specific arrester made from the arrester foil. Thus, for instance, a copper foil is used for an arrester foil from which the anodes are going to be made, and preferably, an aluminum foil is used for arresters from which the cathodes are going to be made. For example, the raw foil consists only of bare metal. As an alternative to this, there can already be a coating on the metal, especially a layer. This is present, for instance, only on one side or else on both sides of the metal. The coating comprises, for example, the appertaining active material, a binder and/or a conductive additive such as, for instance, conductive carbon black or conductive graphite.

Within the scope of the method, the rolls are continuously unrolled at an advancing speed in an advancing direction. In this process, the advancing direction is especially perpendicular to the axis around which the raw foil is wound up and around which the roll is rotated in order for it to be unrolled. The advancing speed is, for example, constant or adapted to the momentary requirements. In particular, this speed is first increased at the start of the method until a desired speed has been reached. The advancing speed corresponds to a speed at which the roll is being unrolled. In particular, the part of the raw foil that is unwound is fed to a laser cutting group.

While the roll is being unrolled, the laser cutting group cuts out connections in an edge area of the unwound raw foil. The connections that are cut out by means of the laser cutting group stay on the remaining constituents of the raw foil, and the constituents located between the connections in the advancing direction are cut off from the rest of the raw foil. In particular, the connections have a rectangular shape, and the edge area extends along the entire advancing direction. For example, the edge area reaches from one edge of the raw foil extending along the advancing direction all the way to a center area and it corresponds at the maximum to 10%, 5% or 2% of the extension perpendicular to the edge.

If the raw foil has already been provided with the coating, then the edge area is advantageously free of the coating. If the coating is not yet present, then it is practical to coat only the area that is not formed by means of the connections. The distance of the connections in the advancing direction relative to each other that have been cut out by means of the laser cutting group is, for instance, constant. In this case, several identical arresters are advantageously made from the arrester foil, and the electrodes made from the arresters are especially stacked one above the other. As an alternative to this, the distance of the connections in the advancing direction changes and, using the arrester foil, especially an electrode is produced that is wound up, especially to form a so-called “jelly roll”.

For example, the raw foil from which the connections have been cut out is the arrester foil, or else additional work steps are required for the complete production of the arrester foil such as, for example, optionally providing it with a coating. At the very least, however, it is possible to use the arrester foil to create one or more arresters for the batteries.

Since the connections are cut out during the continuous unrolling of the roll, there is no need to accelerate and decelerate the raw foil, since this would lead to a relatively high mechanical stress of the raw foil. In this manner, damage to the raw foil is avoided during the production of the arrester foil, thus reducing the number of rejects. It is also possible to adapt the advancing speed to certain requirements and, for example, to adapt the quantity of produced arrester foil to the momentary demands. Consequently, the flexibility is increased. In this context, it is also possible to select a relatively high advancing speed and thus a relatively high production speed for the arrester foil, without this entailing the need for several laser cutting groups. As a result, the manufacturing costs of a production device for producing the arrester foil that is being processed by means of the method are reduced. Moreover, since the laser cutting group has relatively few moving parts, it is easier to adapt the advancing speed.

The laser cutting group preferably comprises a laser by means of which a lens is exposed to light. The lens advantageously makes it possible to deflect the laser beam that is produced by the laser, and this lens is especially provided and configured for this purpose. Suitably, the lens has a driven or at least moveable mirror for this purpose. Advantageously, the laser cutting group also comprises a cutting table with a cutting template. In particular, the area of the raw foil that is to be cut by means of the laser cutting group is arranged between the lens and the cutting table. The cutting template is especially adapted to the way in which the laser beam is guided by means of the lens. Advantageously, the cutting template at least partially prescribes the shape of one of the arresters, and when the laser beam penetrates into the raw foil, it strikes a certain part of the cutting template where back-scattering to the raw foil is avoided.

Preferably, the cutting point of the laser cutting group, that is to say, the point where the laser cutting group cuts into the edge area, is set as a function of the advancing speed. Thus, it is possible to select different advancing speeds, whereby the connections are always cut in the desired manner. This reduces the number of rejects. Here, it is also possible to vary the advancing speed and, for example, at the onset, that is to say, at the start of the unrolling of the raw foil from the roll, during which the roll is moved at a relatively low speed, the connections can already be cut out in accordance with the given specifications, without this giving rise to rejects. In this process, for instance, the cutting point of the laser cutting group is set only as a function of the advancing speed or preferably also as a function of additional parameters such as preferably the momentary location/position of the laser cutting group.

In one embodiment, edges of the connections that run perpendicular to the advancing direction are created by guiding the cutting point at an angle that is diagonal to the advancing direction, whereby the cutting point is moved at a given cutting speed. Here, for example, a component of the cutting speed that runs perpendicular to the advancing direction is selected as a function of the advancing speed. Consequently, the movement speed of the cutting point, that is to say, the cutting speed, is selected as a function of the advancing speed and is set in this process. Then, even at different advancing speeds, it is always the case that an edge is cut into the raw foil running perpendicular to the advancing direction, so that the shape of the connections is essentially independent of the advancing speed. Advantageously, the angle at which the cutting point is guided is constant. Therefore, it is possible to always use the same cutting template, which is why the production costs are lowered.

In an alternative to this, for example, the angle is selected as a function of the advancing speed whenever edges that run perpendicular to the advancing direction are to be created. For example, the cutting speed is selected here to be constant, thereby simplifying the actuation of a lens that might be present. In particular, the cutting template is configured to be adjustable, and it has, for instance, a slit that can be adjusted. The slit here is especially adjusted as a function of the angle.

In another alternative, the laser cutting group is moved in the advancing direction at the advancing speed while each of the connections is being cut out, so that no relative movement is made between the laser cutting group and the raw foil. In this manner, it is possible to actuate the laser cutting group in the same manner as when the raw foil has been brought to a standstill. Thus, an actuation of the laser cutting group is simplified and more intuitive. Once each connection has been cut out, the laser cutting group is advantageously moved into the original position, in other words, opposite to the advancing direction. As soon as the raw foil has then been unwound in such a way that a place where another connection is to be cut out has reached the laser cutting group, said raw foil is once again moved in the advancing direction at the advancing speed.

Preferably, the raw foil in which the connections have been made corresponds to the arrester foil. For example, the part of the raw foil that already has the connections is cut to length, especially if the electrodes produced by the arresters are supposed to be stacked one above the other in layers. In other words, the arresters are individuated from the raw foil that has the connections and that especially forms the arrester foil. As an alternative to this, the part of the raw foil that already has the connections is once again rolled up so that inventory can be kept on hand. Therefore, it is possible to prefabricate several arrester foils and to use them to produce batteries as the need arises.

The production device serves to produce an arrester foil and it is suitable, especially provided and configured for this purpose. In particular, the production device is operated in such a way that the arrester foil or at least a precursor thereof is made by means of said device. The production device has a receiving station for a roll comprising a metallic raw foil. Moreover, the production device has an unwinding device for the roll. In particular, the unwinding device has an electric motor or some other kind of drive by means of which the roll is driven. Furthermore, the production device has a laser cutting group.

The production device is operated according to a method in which a roll of metallic raw foil is provided. In particular, the raw foil is received by the receiving station. While the roll is being continuously unrolled at an advancing speed in the advancing direction, the laser cutting group cuts out connections in an edge area of the unwound raw foil extending along the advancing direction. The unwinding device is advantageously used for the unrolling procedure. In particular, the production device has a control unit that is suitable, especially provided and configured to carry out the method. In a suitable manner, the production device is used to carry out the method.

Advantageously, the production device additionally comprises a rolling device so that the processed raw foil that especially forms the arrester foil, that is to say, the raw foil from which the connections are cut out, is wound up. The laser cutting group advantageously comprises a laser. When the laser is being operated, it generates a laser beam that is especially directed at a lens of the laser cutting group. Advantageously, the lens is configured to be adjustable, so that the lens can appropriately guide and/or deflect the laser beam. Moreover, the laser cutting group advantageously has a cutting table with a cutting template. The cutting template has, for example, one slit, several slits or other cutouts, whereby the object to be cut, especially the raw foil, is placed between the lens and the cutting table while the laser cutting group is in operation. In this context, the cutouts in the cutting table are such that, when the object to be cut, that is to say, the raw foil, is penetrated by the laser beam, the latter strikes the slits so that an uncontrolled back-scatter onto the raw foil is avoided.

Therefore, the invention also relates to the use of the production device for carrying out the method and it also relates to an arrester foil produced according to the method and/or by means of the production device, as well as to a battery made thereof.

The advantages and refinements described in conjunction with the method can also be applied analogously to the production device, to the use, to the arrester foil, to the battery as well as among each other and conversely.

### BRIEF DESCRIPTION OF THE DRAWINGS

Embodiments of the invention are explained in greater detail below with reference to a drawing. The following is shown:

FIG. 1 shows schematically simplified, a motor vehicle that has a high-voltage battery with several identically designed batteries,

FIG. 2 shows schematically in a sectional view, one of the batteries having two arresters that have been made from an arrester foil,

FIG. 3 shows a top view of a section of a raw foil,

FIG. 4 shows according to FIG. 3, an arrester foil made from the raw foil,

FIG. 5 shows a method for producing an arrester foil for batteries,

FIG. 6 shows a top view of a production device having a cutting template for producing an arrester foil,

FIG. 7 shows the cutting template in a front view,

FIGS. 8 to 10 show another variant of the cutting template in various operational positions,

FIG. 11 shows according to FIG. 6, a section of an alternative of the production device, and

FIG. 12 shows a front view of the production device according to FIG. 11.

Corresponding parts are provided with the same reference numerals in all of the figures.

### DETAILED DESCRIPTION OF THE INVENTION

FIG. 1 schematically shows a motor vehicle 2 in the form of a passenger car. The motor vehicle 2 has a number of wheels 4 of which at least some are powered by means of a drive 6 comprising an electric motor. Thus, the motor vehicle 2 is an electric vehicle or a hybrid vehicle. The drive 6 has a converter by means of which the electric motor is supplied with power. The converter of the drive 6, in turn, is supplied with power by means of an energy storage means 8 in the form of a high-voltage battery. For this purpose, the drive 6 is connected to an interface 10 of the energy storage means 8 that is installed in a housing 12 of the energy storage means 8, said housing 12 being made of stainless steel. Multiple battery modules are arranged inside the housing 12 of the energy storage means 8, some of which are electrically connected to each other in series and these, in turn, are electrically connected to each other in parallel. The electric assembly of the battery modules is electrically contacted with the interface 10 so that, during operation of the drive 6, the battery module is discharged or charged (recuperation). Owing to the electric interconnection, the electric voltage, amounting to 400 V, that is supplied at the interface 10 is a multiple of the electric voltage supplied by each of the identically designed battery modules.

Each of the battery modules, in turn, comprises several batteries 14, two of which are shown here. The batteries 14 of each battery module are electrically connected in parallel in some cases, and otherwise electrically connected in series, so that the electric voltage provided by each battery module amounts to a multiple of the electric voltage supplied by one of the batteries 14.

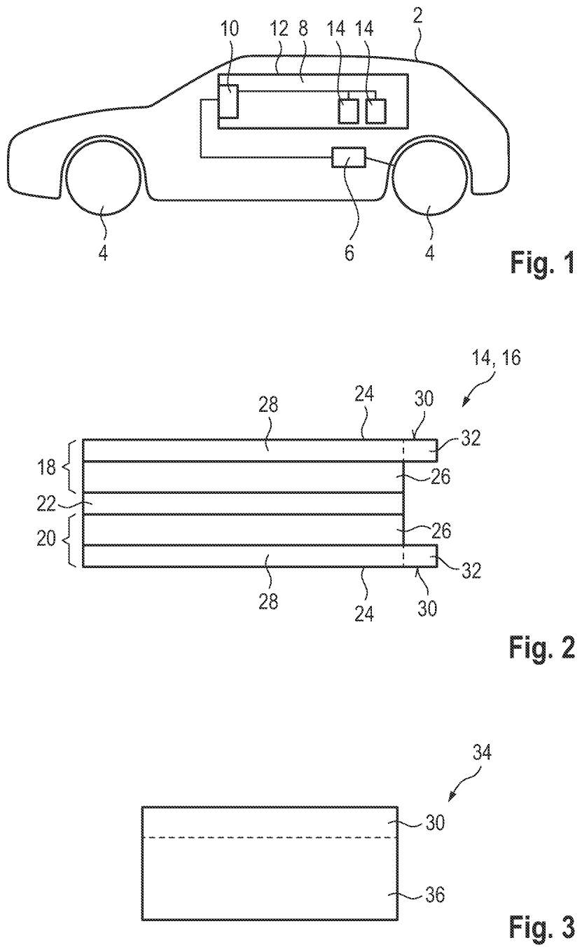

FIG. 2 is a sectional view showing sections of one of the identically designed batteries 14. The battery 14 has several identically designed battery cells 16 of which only a single one is shown here. The battery cell 16 comprises an anode 18 and a cathode 20 which are each configured so as to be flat, and between which a separator 22 is arranged so as to be in contact with them. The individual battery cells 16 are stacked one above the other to form the battery 14, whereby there is another separator (not shown here) arranged between the individual battery cells 16, so as to form a cell stack.

The anode 18 and the cathode 20 each have an arrester 24, which is also referred to as a carrier, and which is always a metal foil. The arrester 24 is a copper foil in the case of the anode 18, and the arrester 24 is an aluminum foil in the case of the cathode 20. The arresters 24 are each provided with a coating 26 on the side facing the separator 22, and said coating comprises an active material such as NMC and a binder as well as a conductive additive. In the case of the anode 18, the conductive additive is, for example, graphite while in the case of the cathode 20, it is conductive carbon black.

In each case, here, it is not then entire arrester 24 that is provided with the coating 26 but rather only a main element 28, and each connection 32 located in an edge area 30 is free of the coating 26. The size of the main element 28 and thus also the size of the coating 26 corresponds to the size of the separator 22. In the mounted state, additional components are electrically joined to the connections 32, for example, the connections 32 of the additional battery cells 16 or connections of the battery 14, especially via so-called busbars.

FIG. 3 shows a section of a raw foil 34 from which the arresters 24 are made. The raw foil 24 is metallic and, depending on whether anodes 18 or cathodes 20 are to made from it, they are configured as copper foil or aluminum foil. In one embodiment, the bare metal of the raw foil 24 is provided with a layer (not shown here) or already with the coating 26. The raw foil 34 has the edge area 30 that extends along its lengthwise direction and it also has a main area 36 that forms the remaining part of the raw foil 34 and that will form the main element 28 of the appertaining electrode, that is to say, either the anode 18 or the cathode 20.

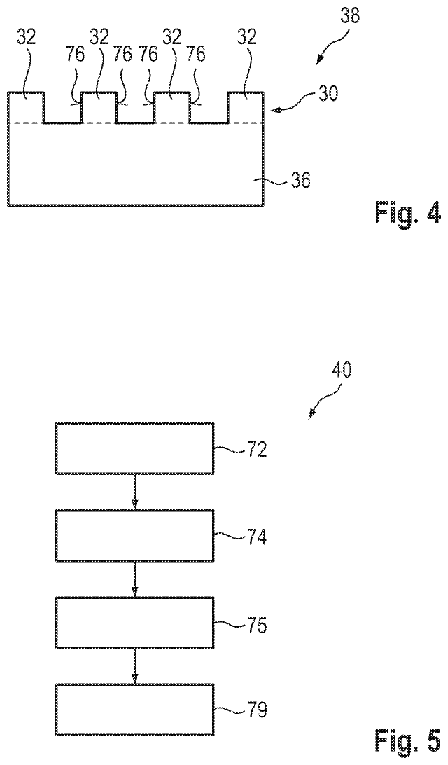

The raw foil 34 is used to produce an arrester foil 38, which is shown in FIG. 4. The arrester foil 38 also has the main area 36 that has not been changed. In contrast, the connections 32 have been cut out in the edge area 30. The parts of the raw foil 34 located between the connections 32, however, have been removed. The shape of the connections 32 is rectangular and the distance of the connections 32 relative to each other is constant. The individual arresters 24 are made from the arrester foil 38 in that the arrester foil is cut to length. For this purpose, the arrester foil 38 is cut, whereby the cut is perpendicular to the course of the edge area 30. In this manner, the arrester foil 38 is individuated, so that the arresters 24 are created. Here, each of the arresters 24 is associated with one of the connections 32 and the size of the arresters 24 is the same.

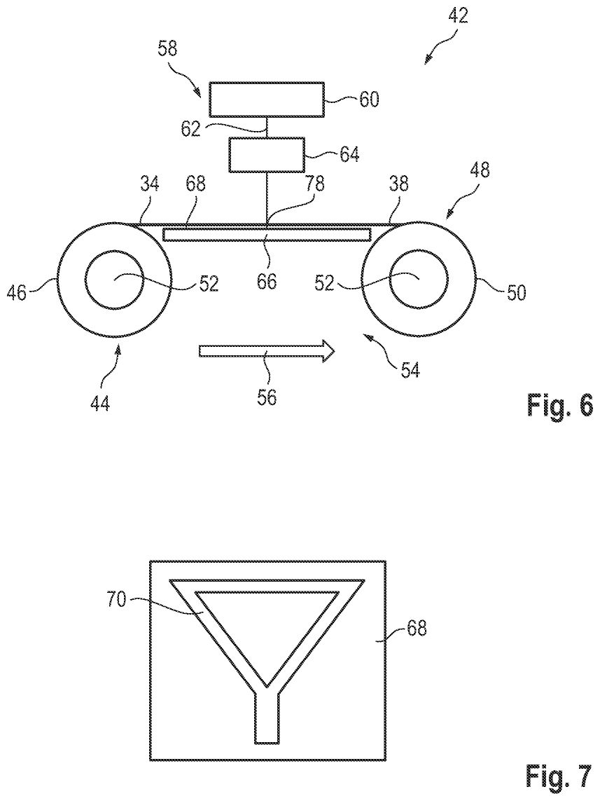

FIG. 5 shows a method 40 for producing the arrester foil 38, which makes use of a production device 42 depicted in a top view in FIG. 6. For this purpose, the production device 42 has a control unit (not shown here), which is suitable, provided and configured to carry out the method 40. In other words, the production device 42 is operated according to the method 40.

The production device 42 also has a receiving station 44 for a roll 46 which has been made by rolling up the metallic raw foil 34. The production device 42 also comprises a rolling device 48 having another roll 50. The rolling device 48 as well as the receiving station 44 each have a drive 52 by means of which the roll 46 or the additional roll 50 is driven. The drives 52 are constituents of an unwinding device for the roll 46, and when the drive 52 is in operation, the roll 46 and then the raw foil 46 are unwound in an advancing direction 56 and wound up onto the additional roll 50 which is situated downstream from the roll 46 in the advancing direction 56.

A laser cutting group 58 that is equipped with a laser 60 is arranged between the receiving station 44 and the rolling device 48. During operation, a laser beam 62 is generated by means of the laser 60 and this beam is directed at a lens 64 of the laser cutting group 58. The lens 64 has a mirror (not shown here) that is movably mounted and driven. In this context, it is possible to change the course of the laser beam 62 by adjusting the lens 64. The lens 64 directs the laser beam 62 at a cutting table 66 which has a cutting template 68. Here, when the raw foil 34 is unwound from the roll 46 and moved in the direction of the rolling device 48 in the advancing direction 56, said raw foil 34 is moved through between the lens 64 and the cutting table 66. The cutting template 68—at least in part—forms the delineation of the cutting table 66 facing the raw foil 34. The cutting template 68 is shown in FIG. 7 in a top view as seen from the lens 64. It has a triangular slit 70.

The method 40 provides that, in a first work step 72, the roll 46 with the metallic raw foil 34 is prepared. For this purpose, the roll 46 is placed into the receiving station 44. In a subsequent second work step 74, the roll 46 is continuously unrolled at an advancing speed in the advancing direction 56 and thus passed through the laser cutting group 58. In this process, the edge area 30 extends along the advancing direction 56.

In a subsequent third work step 75, the connections 32 are cut out by means of the laser cutting group 58 in the edge area 30 of the unwound raw foil 34 while the roll 46 is continuously being unrolled at the advancing speed, in other words, the unrolled part of the raw foil 34 is being moved at the advancing speed in the advancing direction 56. The connections 32 each have edges 76 that run perpendicular to the course of the edge area 30 and that are thus also perpendicular to the advancing direction 56. In order to cut these edges 76 of the connections 32, which run perpendicular to the advancing direction 56, a cutting point 78, that is to say, the point where the laser beam 62 strikes the raw foil 34, is guided at an angle that is diagonal to the advancing direction 56.

The cutting point 78 is guided at a cutting speed that is selected as a function of the advancing speed. In this process, the component of the cutting speed that runs perpendicular to the advancing direction 56 as well as the component of the cutting speed that runs parallel to the advancing direction 56 are selected as a function of the advancing speed. Here, the cutting point 78 is always moved in such a way that it consistently strikes the triangular slit 70 that is covered by means of the raw foil 34. In other words, the cutting point 78 is moved along the triangular shape of the slit shown in FIG. 7. Thus, the part of the laser beam 62 that penetrates through the raw foil 34 after the cutting procedure is always located within the slit 70. Since the cutting speed is selected as a function of the advancing speed, that is to say, the speed at which the raw foil 34 is being unwound, the edges 76 are always cut perpendicular to the course of the edge area 30. Thus, at a relatively low advancing speed, a low cutting speed is also selected, in contrast to which, at a high advancing speed, a greater cutting speed is used.

Once the raw foil 34 has passed the laser cutting group 58 in the advancing direction 56, said raw foil 34 has the connections 32 and the arrester foil 38 is produced. In a fourth work step 79, the arrester foil 38 is then wound up onto the rolling device 48 to form an additional roll 48 so that the part of the raw foil 34 that already has the produced connections 32 is once again wound up. In this context, the raw foil 34 is also unwound from the roll 46, thanks to the drive of the additional roll 50.

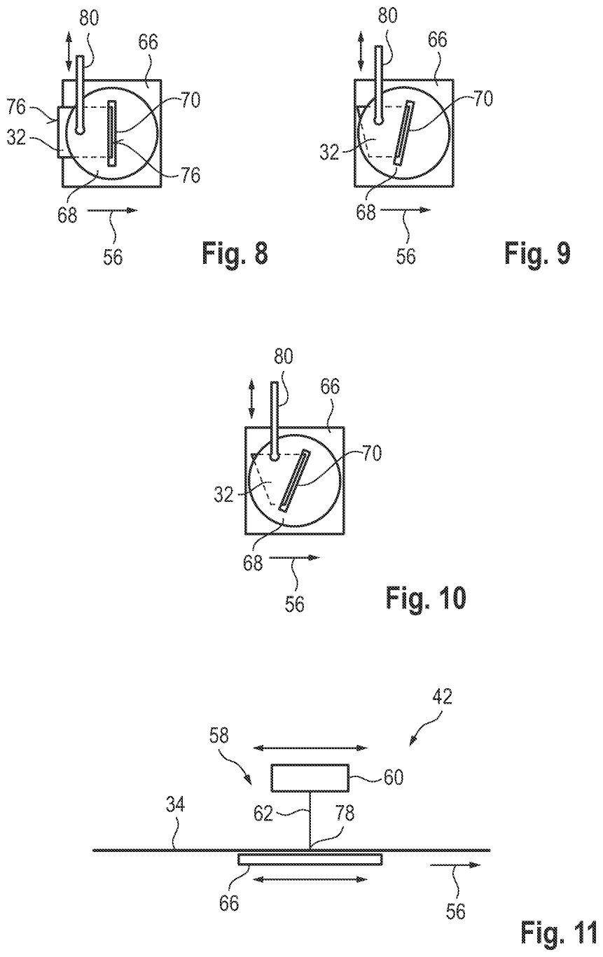

FIGS. 8 to 10 show an alternative embodiment of the cutting table 66 with the cutting template 58 [sic]. The cutting template 68 is circular and mounted so as to rotate around an axis that runs through the mid-point of said cutting template 68. Here, the axis is also perpendicular to the course of the raw foil 34. The slit 70 of the cutting template 68 now has a rectilinear configuration. A lever 80 engages eccentrically with the cutting template 68 so that, when the lever 80 is moved, the cutting template 68 and thus also the slit 70 are swiveled with respect to the advancing direction 56, whereby the slit 70 encloses an angle relative to the advancing direction 56.

In FIG. 8, the angle is 90° and successively decreases towards FIG. 10. Moreover, the figures each show an overlap of one of the connections 32. When the raw foil 34 is at a standstill during the cutting procedure with the laser cutting group 58, the slit 70 is set as depicted in FIG. 8, so that it runs perpendicular to the advancing direction 56. The cutting point 78 is guided along above the slit 70, thereby creating the edges 76 of the appertaining connection 32 that run perpendicular to the advancing direction 56.

However, if as set forth by the method 40, the raw foil 34 is continuously being unrolled during the cutting procedure, then the raw foil 54 [sic] is moved relative to the cutting table 66. Therefore, in order to create the edges 76 that run perpendicular, the cutting point 78 is guided at an angle that is diagonal to the advancing direction 56, whereby the same cutting speed is always selected. Here, the cutting point 78 is moved above the slit 70, so that the angle between the slit 70 and the advancing direction 56 is also selected as a function of the advancing speed. Thus, at a relatively high advancing speed, as shown in FIG. 10, a relatively small angle to the advancing direction 56 is selected, in contrast to which, at a relatively low speed, the deviation of the angle from 90° is relatively small, as shown in FIG. 9. In this manner, the connections 32 are cut out rectangularly, even when the cutting point 78 is moved essentially in a trapezoidal pattern.

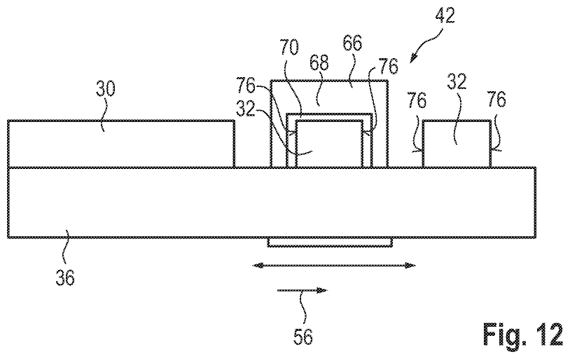

FIG. 11 shows a section of a top view and FIG. 12 shows a section of a side view of another embodiment of the production device 42, whereby the receiving station 44, the rolling device 48 and the unwinding device 54, which are not shown here, are not changed. The laser cutting group 58 also has the laser 60 as well as the lens 64, which is not shown here and by means of which the laser beam 62 is appropriately guided. The cutting table 66 is also present, whereby the raw foil 34 is guided through between the lens 64 and the cutting table 66.

The entire laser cutting group 58, however, is no longer stationary, as was the case in the preceding embodiments, but rather, it is configured movably, namely, in the advancing direction 56. While one of the connections 32 is being cut out by means of the laser cutting group 58, the laser cutting group 58 is moved in the advancing direction 56 together with the raw foil 34. Here, the laser cutting group 58 is moved at the advancing speed, at least when the cutting procedure is being carried out. Consequently, the shape of the slit 70 of the cutting template 68 corresponds exactly to the outer contour of one of the connections 32, and the cutting point 78 is guided along the course of the slit 70 during the movement. As soon as the appertaining connection 32 has been cut out, the entire laser cutting group 58 is moved counter to the advancing direction 56 into the original position, and as soon as another one of the connections 32 is to be created, the entire laser cutting group 58 is once again moved in the advancing direction 56, whereby the laser beam 62 is once again moved along the slit 70. Thus, here too, the cutting point 78 is adjusted as a function of the advancing speed, whereby for this purpose, at least at times, the entire laser cutting group 58 is moved. Therefore, in summary, the laser cutting group 58 is moved in the advancing direction 56 at the advancing speed while each of the connections 32 is being cut out.

In all of the variants, the cutting point 78 is adjusted as a function of the advancing speed, so that the production device 42 can be operated at various advancing speeds, whereby the course of the edges 76 is always perpendicular to the advancing direction 56 and thus to the edge area 30. Thus, the part of the raw foil 34 that is being processed by means of the laser cutting group 58 during the operation of the production device 42 can also be used as the arrester foil 38 after completion of the processing. This reduces the number of rejects.

The invention is not limited to the embodiments described above. Rather, other variants of the invention can also be derived by the person skilled in the art without departing from the subject matter of the invention. In particular, all of the individual features described in conjunction with the individual embodiments can also be combined with each other in another manner without departing from the subject matter of the invention.

### LIST OF REFERENCE NUMERALS

2 motor vehicle
4 wheel
6 drive
8 energy storage means
10 interface
12 housing
14 battery
16 battery cell
18 anode
20 cathode
22 separator
24 arrester
26 coating
28 main element
30 edge area
32 connection
34 raw foil
36 main area
38 arrester foil
40 method
42 production device
44 receiving station
46 roll
48 rolling device
50 additional roll
52 drive
54 unwinding device
56 advancing direction
58 laser cutting group
60 laser
62 laser beam
64 lens
66 cutting table
68 cutting template
70 slit
72 first work step
74 second work step
75 third work step
76 edge
78 cutting point
79 fourth work step
80 lever

1. A method for producing an arrester foil for a battery, comprising:
preparing a roll with a metallic raw foil, and
while the roll is being continuously unrolled at an advancing speed in an advancing direction, cutting out, using a laser cutting group, connections in an edge area of the unwound raw foil extending along the advancing direction.

2. The method according to claim 1, wherein a cutting point of the laser cutting group is set as a function of the advancing speed.

3. The method according to claim 2, wherein edges of the connections that run perpendicular to the advancing direction are created by guiding the cutting point at an angle that is diagonal to the advancing direction, whereby a component of the cutting speed that runs perpendicular to the advancing direction is selected as a function of the advancing speed.

4. The method according to claim 2, wherein edges of the connections that run perpendicular to the advancing direction are created by guiding the cutting point at an angle that is diagonal to the advancing direction, whereby the angle is selected as a function of the advancing speed.

5. The method according to claim 1, wherein the laser cutting group is moved in the advancing direction at the advancing speed while each of the connections is being cut out.

6. The method according to claim 1, wherein the part of the raw foil that already has the connections is once again rolled up.

7. A production device for producing an arrester foil, comprising:
a receiving station for a roll comprising a metallic raw foil,
an unwinding device for unwinding the roll, and
a laser cutting group,
wherein the production device is operated by the method according to claim 1.
